(19) United States
(12) Patent Application Publication
(10) Pub. No.: US 2009/0214174 A1
(43) Pub. Date: Aug. 27, 2009

(54) SELECTION APPARATUS AND METHOD

(75) Inventor: Asuka Wada, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/392,350

(22) Filed: Feb. 25, 2009

(30) Foreign Application Priority Data
Feb. 25, 2008 (JP) 2008-043066

(51) Int. Cl. H04N 5/93; H04N 7/26

(52) U.S. Cl. 386/52; 386/124; 386/E05.001

(57) ABSTRACT

A selection apparatus configured to select a target of recording on a recording apparatus from among a plurality of pieces of digital content data included in a broadcast program includes a first selection unit configured to select digital content data to be output to a reproduction apparatus from among the plurality of pieces of digital content data included in the broadcast program, an output unit configured to output the digital content data selected by the first selection unit to the reproduction apparatus, and a second selection unit configured to select the digital content data that is currently being output by the output unit as a target of recording on the recording apparatus.

### BACKGROUND OF THE INVENTION

1. Field of the Invention

The present invention relates to a method for selecting data to be processed, more specifically, processing on a received digital broadcast signal.

2. Description of the Related Art

In recent years, the telecast communication has been more and more digitized. Under such a circumstance, one broadcast signal is constituted by a plurality of pieces of separable stream data. In this regard, for example, Japanese digital terrestrial broadcasting employs Moving Picture Experts Group (MPEG)-2 system specification as a method for multiplexing stream data. More specifically, a plurality of broadcast programs is transmitted by multicast in a broadcast signal of MPEG transport stream specification.

In this case, one broadcast program is constituted by a plurality of pieces of stream data (content data) and other information. The stream data includes elementary streams (ESs), such as a video ES, an audio ES, a subtitle ES, and a data ES.

Note that in the Japanese digital terrestrial broadcasting specification, the maximum number of elementary streams that can be included in one broadcast program is defined as 12. However, in general, the total number of elementary streams that can be multiplexed into the MPEG transport stream is not limited to this.

Furthermore, a conventional method multiplexes a plurality of video ESs and a plurality of audio ESs in one broadcast program in the case of a multiview broadcast.

In this regard, a conventional method has been discussed for effectively performing processing on a transport stream in which a plurality of broadcast programs and a plurality of elementary streams constituting each broadcast program are multiplexed.

For example, Japanese Patent Application Laid-Open No. 2002-271750 discusses a method for recording only an elementary stream of a broadcast program that has been previously determined at the time of recording thereof. Furthermore, Japanese Patent Application Laid-Open No. 09-51520 discusses a method for selectively concluding a viewing contract with respect to each elementary stream.

However, in the case where a plurality of elementary streams constituting one broadcast program exists, processing on an additional command (a one-touch recording command, for example) from a user may not be efficiently executed according to the type of the additional command. The additional command may also include a search keyword extraction command in addition to the one-touch recording command, for example.

The “one-touch recording” is a function for allowing the user to record a currently viewed broadcast program with a relatively simple operation. Furthermore, the “search keyword extraction” is a function for extracting a related keyword from a currently viewed broadcast program and notifying to the user or recording the extracted search keyword as a candidate of the search keyword to be input to an Internet search engine.

In the case of executing processing based on a user operation for performing one-touch recording, if all elementary streams included in a broadcast program are set as the target of control, the stream data that the user does not consider necessary may also be recorded.

Furthermore, in the case of executing processing based on a user operation for extracting a search keyword, if all elementary streams are set as the search target, the keyword that the user does not desire may be extracted. In this case, the number of operations for performing the search keyword extraction may increase.

Suppose, for example, that the search keyword extraction is performed on a broadcast program having two ESs of a Japanese audio output and an English audio output. In this case, a keyword extracted from the English audio information, which the user does not desire to extract, may be recorded or notified as a result of the extraction.

### SUMMARY OF THE INVENTION

An embodiment of the present invention is directed to a method for efficiently executing recording according to an additional command for a broadcast program on which a plurality of pieces of content data is multiplexed.

According to an aspect of the present invention, a selection apparatus configured to select a target of recording on a recording apparatus from among a plurality of pieces of digital content data included in a broadcast program includes a first selection unit configured to select digital content data to be output to a reproduction apparatus from among the plurality of pieces of digital content data included in the broadcast program, an output unit configured to output the digital content data selected by the first selection unit to the reproduction apparatus, and a second selection unit configured to select the digital content data that is currently being output by the output unit as a target of recording on the recording apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the present invention.

FIG. 1 illustrates an exemplary configuration of a digital television set according to an exemplary embodiment of the present invention.

FIGS. 2A through 2C each illustrate an example of a video output, an audio output, and a viewing configuration according to an exemplary embodiment of the present invention.

FIG. 3 is a flow chart illustrating an exemplary flow of processing performed by a digital television set according to a first exemplary embodiment of the present invention.

FIG. 4 is a flow chart illustrating an exemplary flow of processing for changing a viewing configuration according to the first exemplary embodiment of the present invention.

FIG. 5 illustrates a detailed exemplary configuration of a user command execution unit according to an exemplary embodiment of the present invention.

FIG. 6 is a flow chart illustrating an exemplary flow of processing for extracting a search keyword according to the first exemplary embodiment of the present invention.

FIG. 7 is a flow chart illustrating an exemplary flow of processing for starting one-touch recording according to the first exemplary embodiment of the present invention.

FIG. 8 is a flow chart illustrating an exemplary flow of processing for starting one-touch recording according to a second exemplary embodiment of the present invention.

FIG. 9 illustrates an example of a viewing configuration including a history-added viewing state according to a third exemplary embodiment of the present invention.

FIG. 10 is a flow chart illustrating an exemplary flow of processing for starting one-touch recording according to the third exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

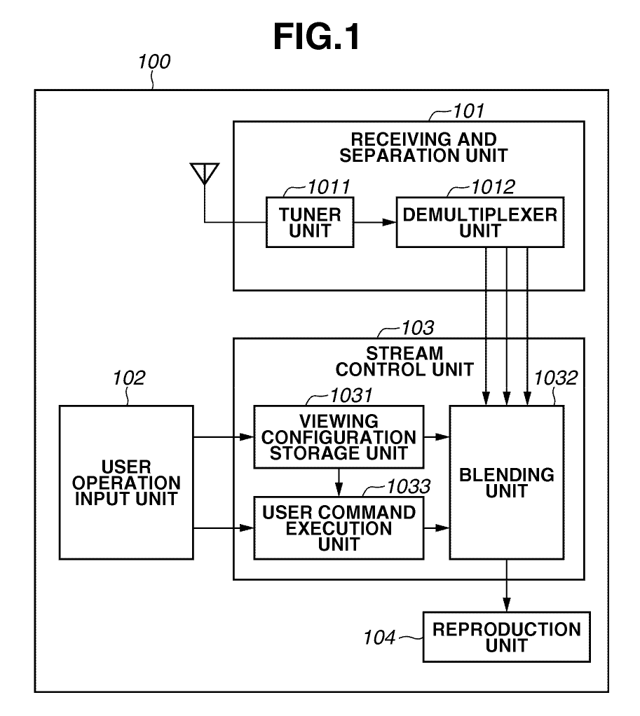

FIG. 1 illustrates an exemplary configuration of a digital television set 100 according to a first exemplary embodiment of the present invention. Referring to FIG. 1, the digital television set 100 includes a receiving and separation unit 101. The receiving and separation unit 101 includes a tuner unit 1011 and a demultiplexer unit 1012.

The tuner unit 1011 uses an antenna terminal to receive a digital broadcast signal transmitted from a broadcast station. Furthermore, the tuner unit 1011 supplies the received digital broadcast signal to the demultiplexer unit 1012. The demultiplexer unit 1012 demodulates the digital broadcast signal supplied from the tuner unit 1011. Furthermore, the demultiplexer unit 1012 executes an error correction on the demodulated digital signal.

Furthermore, the demultiplexer unit 1012 descrambles the digital signal into a transport stream by using a scramble key that is separately supplied and a built-in descrambler.

In the present exemplary embodiment, the transport stream includes multiplexed data of a plurality of broadcast programs. Furthermore, in the data of each broadcast program, a plurality of video ESs, audio ESs, subtitle ESs, and data ESs is multiplexed. The demultiplexer unit 1012 divides the transport stream into a plurality of elementary streams. Furthermore, the demultiplexer unit 1012 transfers the elementary streams to a blending unit 1032. The blending unit 1032 will be described in detail later below.

Furthermore, the demultiplexer unit 1012 notifies the type and a packet identifier (PID) of each elementary stream to the blending unit 1032, which have been acquired by separating the transport stream into the elementary stream.

In this regard, for example, the demultiplexer unit 1012 notifies the blending unit 1032 that the PID of a transport (TS) packet for transmitting video 1 of broadcast program 1 multiplexed in the currently processed the transport stream is “0x00” and that the PID of video 2 of the broadcast program 1 is “0x01”.

A user operation input unit 102 receives various user operations input to the digital television set 100. The user operation may include a selection operation for selecting (changing) a stream to be output from the blending unit 1032 to the reproduction unit 104.

After receiving the selection operation, the user operation input unit 102 supplies the type of the selected stream to a viewing configuration storage unit 1031 of a stream control unit 103.

The selection operation of the stream to be viewed can be input by various input methods. In this regard, for example, in the case of changing the outputting broadcast program, the selection operation is performed by pressing a channel button (not illustrated) of the user operation input unit 102.

Furthermore, for example, in the case of changing the outputting audio data to a sub audio from a main audio, the selection operation is performed by pressing an audio switching button. Furthermore, in the case of changing an outputting video data, the selection operation is performed by pressing a video switching button.

On the other hand, after receiving an input of an additional command from the user, the user operation input unit 102 supplies the received additional command to a user command execution unit 1033 of the stream control unit 103.

The additional command includes a command for executing the one-touch recording or a command for extracting a search keyword, for example. The one-touch recording is a function for recording the broadcast program currently viewed by the user with a relatively simple operation (by pressing the one-touch recording button, for example).

In the present exemplary embodiment, the recording executed based on the command for executing the one-touch recording includes the recording of audio information or data as well as the recording of an image.

On the other hand, the search keyword extraction is a function for extracting a keyword from a broadcast program that is currently being viewed by the user and notifying the extracted keyword to the user as a candidate of the search keyword to be input to an Internet search engine.

It is also useful if the search keyword extraction function automatically inputs the extracted keyword instead of notifying the extracted keyword to the user. Furthermore, it is also useful if the extracted keyword is used as information to be used for later searching for the recorded broadcast program.

The user operation input unit 102 can be implemented by an operation device, such as a remote controller, a keyboard, a mouse, a digitizer, a touch panel, a joystick, or a controller of a gaming machine, or a combination thereof, for example.

The stream control unit 103 includes the viewing configuration storage unit 1031, the blending unit 1032, and the user command execution unit 1033. The viewing configuration storage unit 1031 receives an operation for selecting (changing) a stream to view input via the user operation input unit 102 and stores the received operation as the current viewing configuration.

By referring to the received stream selection operation, the viewing configuration storage unit 1031 can recognize that the user has selected video 1 of broadcast program 1 and a main audio thereof.

In addition, the viewing configuration storage unit 1031 receives the type of the elementary stream and PID correspondence information from the blending unit 1032, which have been generated at the time of separating the digital signal into elementary streams by the demultiplexer unit 1012.

Furthermore, the viewing configuration storage unit 1031 notifies the blending unit 1032 of the PID of the elementary stream to be output to the reproduction unit 104 according to the stored viewing configuration and the correspondence information received from the blending unit 1032.

That is, the blending unit 1032 selects content data to be output from among a plurality of pieces of content data (elementary streams) included in a broadcast program.

Furthermore, the blending unit 1032 extracts the elementary stream included in the current viewing configuration from the elementary stream that has been transmitted from the demultiplexer unit 1012 according to the instruction from the viewing configuration storage unit 1031.

More specifically, the blending unit 1032 extracts the elementary stream based on the PID of the elementary stream to be output to the reproduction unit 104, which has been instructed from the viewing configuration storage unit 1031. Furthermore, the blending unit 1032 outputs the extracted elementary stream to the reproduction unit 104.

That is, the blending unit 1032 outputs the content data (elementary stream) selected by the viewing configuration storage unit 1031 to the reproduction unit 104.

Note that during the output processing, the blending unit 1032 executes processing for blending the video and audio data as necessary.

Furthermore, the blending unit 1032 decodes each of the selected elementary streams with a compliant decoder. For example, the video ES compliant with MPEG-2 video format is converted into continuous raster images with a compliant video decoder.

In this regard, it is useful if the decoding processing is executed during the time period from the time the demultiplexer unit 1012 separates the digital signal into elementary streams to the time the blending unit 1032 outputs the elementary stream to the reproduction unit 104.

The user command execution unit 1033 executes the processing based on the additional command from the user, which has been supplied from the user operation input unit 102, and the viewing configuration stored on the viewing configuration storage unit 1031. Furthermore, the user command execution unit 1033 stores the information acquired as a result of the processing.

More specifically, the user command execution unit 1033 executes the processing on the additional command and records the information that has been acquired by the processing on a recording unit (the recording apparatus) (not illustrated) In this regard, the additional command includes the command for executing the one-touch recording and the command for extracting the search keyword, for example.

In the case where the command for executing the one-touch recording has been executed, the user command execution unit 1033 selects the elementary stream to be recorded according to the viewing configuration stored on the viewing configuration storage unit 1031.

More specifically, the user command execution unit 1033 selects the content data (elementary stream) currently being output by the blending unit 1032 as the target of recording. Then, the user command execution unit 1033 records the selected elementary stream on the recording unit.

In the present exemplary embodiment, the selected elementary stream is recorded. However, the present exemplary embodiment is not limited to this. That is, it is also useful if all the elementary streams that have been transmitted to the blending unit 1032 are temporarily recorded and unnecessary data is deleted according to the viewing configuration.

By performing the following processing, the area necessary for the recording can be reduced. That is, the recording unit records content data (elementary stream) according to the selection performed by the user command execution unit 1033.

On the other hand, in the case where the command for extracting the search keyword has been issued, the user command execution unit 1033 selects the stream from which the search keyword to be recorded is extracted from the currently viewed elementary stream according to the viewing configuration stored on the viewing configuration storage unit 1031.

Then, the user command execution unit 1033 selects the content data (elementary stream) currently being output by the blending unit 1032 as the target of recording.

Furthermore, the user command execution unit 1033 extracts the search keyword from the selected stream. Then, the user command execution unit 1033 transfers the extracted keyword to the blending unit 1032 and the recording unit.

Furthermore, the blending unit 1032 outputs the keyword extraction result to the reproduction unit 104 so that the extracted keyword can be displayed by the reproduction unit 104.

Moreover, the recording unit records the keyword transferred from the user command execution unit 1033.

As described above, the recording unit according to the present exemplary embodiment records the keyword extracted from the currently viewed elementary stream. However, the present exemplary embodiment is not limited to this. That is, it is also useful if all the keywords extracted from the elementary streams transmitted to the blending unit 1032 are temporarily recorded and an unnecessary keyword is deleted according to the viewing configuration

In this regard, the recording of unnecessary keyword can be prevented or at least suppressed to a minimum by performing the following processing.

That is, the recording unit records the keyword extracted from the content data according to the selection by the user command execution unit 1033. The reproduction unit 104 reproduces the video data and the audio data that has been selected and blended by the blending unit 1032 of the stream control unit 103. More specifically, with respect to the component of the reproduction unit 104, a reproduction device, such as a video monitor, a speaker, and a headphone, can be used for reproducing the video and audio data.

Note here that the digital television set 100 according to the present exemplary embodiment executes the operation of the stream control unit 103 (each of the viewing configuration storage unit 1031, the user command execution unit 1033, and the blending unit 1032) with the software stored on the digital television set 100.

That is, a central processing unit (CPU) that controls the entire operation of the digital television set 100 reads and executes the control program from a read-only memory (ROM) to execute the processing. However, it is also useful if the processing performed by the above-described components is executed by dedicated hardware.

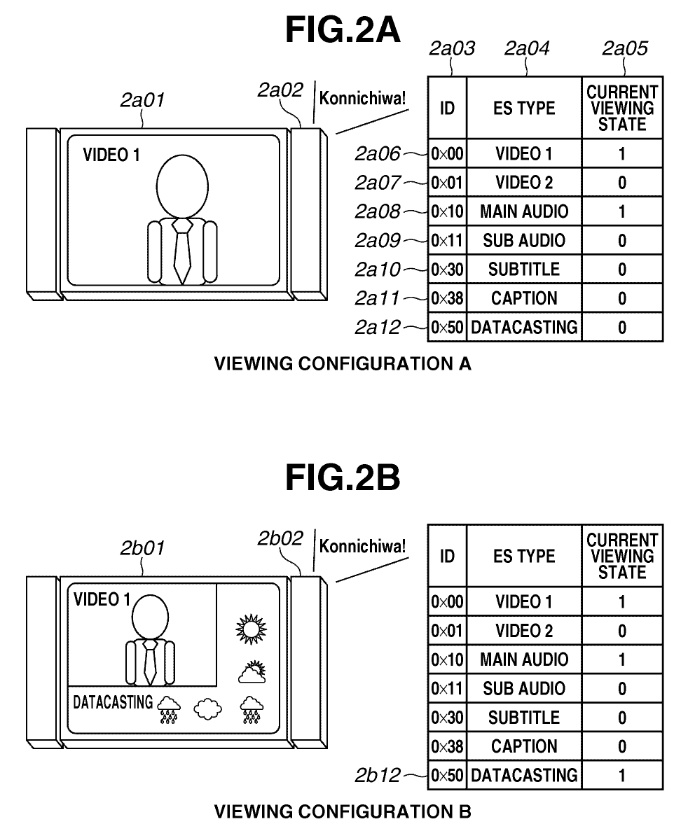

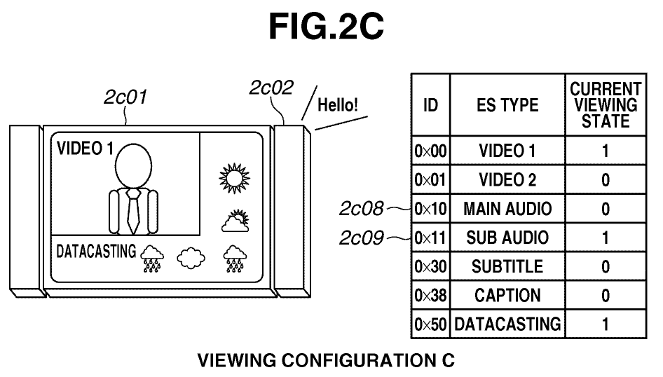

Now, information included in the viewing configuration stored on the viewing configuration storage unit 1031 and the video and the audio data reproduced by the reproduction unit 104 according to the present exemplary embodiment will be described in detail below with reference to FIGS. 2A through 2C.

Referring to FIG. 2A, a viewing configuration A indicates a default video and audio output when the digital television set 100 is powered on and a default viewing configuration stored on the viewing configuration storage unit 1031 at this timing.

The default viewing configuration according to the present exemplary embodiment includes a setting for reproducing the video 1 and the main audio thereof of the currently broadcasted program with respect to the same channel as the broadcast program that has been previously reproduced.

Note that the default information may be the viewing configuration applied at the time of the reproduction of the last content or the viewing configuration previously set by the user.

A display screen 2a01 of the reproduction unit 104 displays video data. In the example illustrated in FIG. 2A, the video 1 is reproduced in a full screen display mode according to the default viewing configuration. A speaker 2a02 of the reproduction unit 104 reproduces audio information. In the example illustrated in FIG. 2A, the main audio is reproduced according to the default viewing configuration.

A list displayed on the right side of the viewing configuration A in FIG. 2A indicates information about the viewing configuration stored on the viewing configuration storage unit 1031.

A column 2a03 indicates the PID of each elementary stream. However, the present invention is not limited to this. That is, any information that allows the user to identify the elementary stream can be used as the ID that the column 2a03 indicates. Accordingly, it is also useful if an ID, such as a component tag, is previously allocated to each elementary stream and used as the ID indicated in the column 2a03 instead of the PID.

In this regard, the ID can be acquired at the time the digital broadcast signal is separated into elementary streams by the demultiplexer unit 1012. Furthermore, it is also useful if an ID uniquely allocated by the viewing configuration storage unit 1031, for example, is used.

A column 2a04 indicates the type of each elementary stream. The type of the elementary stream includes the type of each component of a broadcast program such as the video 1, the video 2, the main audio, the sub audio, or the subtitle.

In the present exemplary embodiment, two video elementary streams are multiplexed. However, the present invention is not limited to this. That is, three or more video ESs can be multiplexed. Furthermore, in the present exemplary embodiment, two types of the audio ES, namely, the main audio and the sub audio, are multiplexed. However, three or more audio ESs can be multiplexed.

Furthermore, in the present exemplary embodiment, the type of each elementary stream interpreted based on the PID is used as the value indicated in the column 2a04. However, if the ID indicated in the column 2a03 and that indicated in the column 2a04 are overlapped, the overlapping information in the column 2a04 can be omitted.

A column 2a05 indicates whether each elementary stream is currently being viewed. In the example illustrated in FIGS. 2A through 2C, a parameter value “0” (not to be reproduced) is set for the elementary stream that is currently being viewed, while a parameter value “1” (to be reproduced) is set for the elementary stream that is not currently being viewed.

More specifically, in the viewing configuration A illustrated in FIG. 2A, the video 1 and the main audio, whose value for the column 2a05 is “1” (to be reproduced), are currently being viewed. Accordingly, the video 1 indicated in the column 2a06 is reproduced by the reproduction unit 104 as the video output 2a01. The main audio indicated in the column 2a08 is reproduced by the reproduction unit 104 as the audio output 2a02.

With respect to rows 2a06 through 2a12, all elementary streams included in the currently selected broadcast program are registered with respect to each corresponding row.

The viewing configuration B (FIG. 2B) and the viewing configuration C (FIG. 2C) indicate the change in the video and audio output and the viewing configuration, which change is made when the user performs a selection operation for changing the viewing configuration via the user operation input unit 102 in the state of the viewing configuration A (FIG. 2A). The processing will be described in detail later below.

Note that the viewing configuration storage unit 1031 according to the present exemplary embodiment stores all of the elementary streams included in one broadcast program that has been selected by the user, together with the current viewing state.

However, the information about the elementary stream stored on the viewing configuration storage unit 1031 is not limited to this. That is, any information about the currently viewed elementary stream can be stored on the viewing configuration storage unit 1031. For example, it is also useful if the elementary streams included in all of the broadcast programs in the currently processed transport stream are stored together with the viewing state.

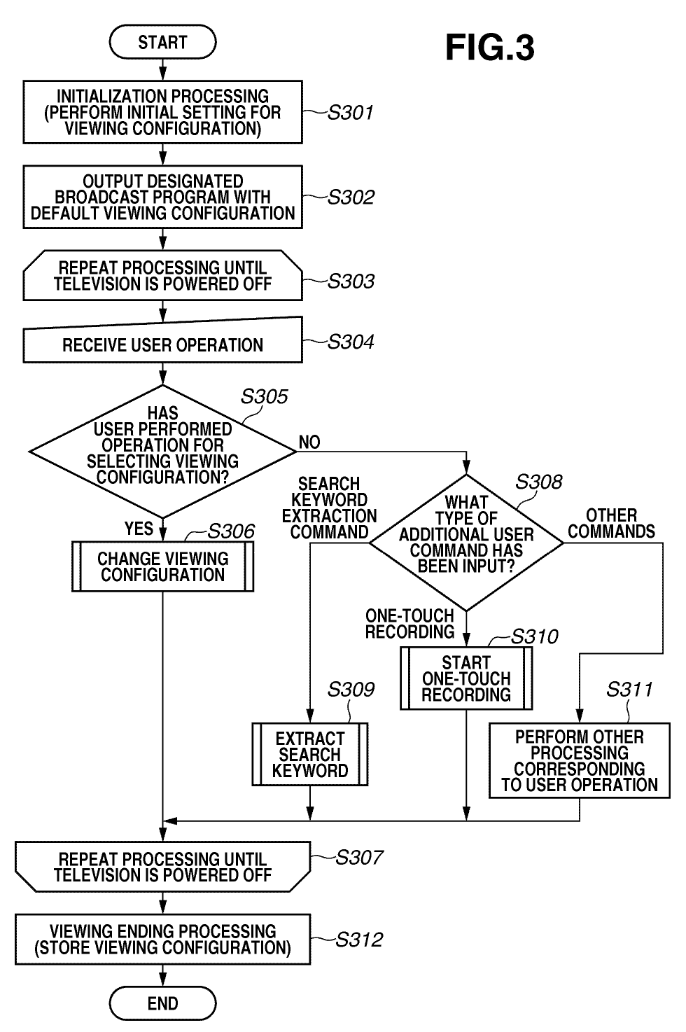

Now, the processing performed by the digital television set 100 according to the present exemplary embodiment will be described in detail below with reference to FIG. 3. FIG. 3 is a flow chart illustrating exemplary processing performed by the digital television set 100 according to the present exemplary embodiment.

The digital television set 100 according to the present exemplary embodiment executes the operation of the stream control unit 103 (each of the viewing configuration storage unit 1031, the user command execution unit 1033, and the blending unit 1032) with the software stored on the digital television set 100. That is, the CPU that controls the entire operation of the digital television set 100 reads and executes the control program from the ROM to execute the processing. However, it is also useful if the processing performed by the above-described components is executed by dedicated hardware.

Referring to FIG. 3, in step S301 (first selection processing: output processing), the CPU of the digital television set 100 initializes the digital television set 100. The initialization processing includes various control operations executed when the digital television set 100 is powered on.

In this regard, for example, the receiving and separation unit 101 receives the digital broadcast signal, starts the separation of the transport stream into elementary streams, and acquires the PID. Furthermore, the receiving and separation unit 101 notifies the acquired PID to the viewing configuration storage unit 1031 together with the type of each ES via the blending unit 1032.

Furthermore, the blending unit 1032 extracts the elementary stream, such as the video and the audio to be output according to the default viewing configuration that has been notified from the viewing configuration storage unit 1031. Furthermore, the blending unit 1032 outputs each extracted elementary stream to the reproduction unit 104.

More specifically, in step S301 in FIG. 3, the viewing configuration storage unit 1031 selects content data to be output from among a plurality of pieces of content data (elementary streams) included in the broadcast program.

Furthermore, the blending unit 1032 outputs the content data (elementary stream) selected by the viewing configuration storage unit 1031 in step S301 to the reproduction unit 104.

The information about the previously selected broadcast program, which is stored on the viewing configuration storage unit 1031, is utilized for the broadcast program reproduced during the initialization processing in step S301 according to the present exemplary embodiment. However, the present invention is not limited to this. That is, it is also useful if a broadcast program is previously stored on the receiving and separation unit 101 as a default reproducing broadcast program and the stored broadcast program is utilized as the broadcast program reproduced in the initialization processing in step S301 (FIG. 3).

Furthermore, the default viewing configuration according to the present exemplary embodiment includes the setting for reproducing the video 1 and the main audio of the broadcast program as described above related to the viewing configuration A (FIG. 2A). However, it is also useful if the viewing configuration set at the time of the last reproduction is utilized.

Furthermore, it is also useful if the value for the component tag set for each elementary stream is referred to and the elementary stream that has been designated as the default elementary stream is allocated to the current viewing configuration.

In step S302, the reproduction unit 104 reproduces the elementary stream decoded and output by the blending unit 1032. As a result, the video and the audio are output to the reproduction unit 104 as illustrated in the viewing configuration A (FIG. 2A).

Processing in step S303 and step S307 indicates that the processing in steps S303 through S311 is repeated until the digital television set 100 is powered off.

In step S304, the user operation input unit 102 receives an input of the user operation from the user. In step S305, the user operation input unit 102 determines which of the selection operation for selecting (changing) the viewing configuration or the additional command the user operation input in step S304 is.

If it is determined in step S305 that the user operation input in step S304 is the selection operation for selecting the viewing configuration, then the processing advances to step S306. On the other hand, if it is determined in step S305 that the user operation input in step S304 is the additional command, then the processing advances to step S307. In this regard, the following description will be made supposing that the user has input the viewing configuration selection operation in step S304.

In the present exemplary embodiment, the user operation input unit 102 determines the type of the user operation. However, the present invention is not limited to this. That is, it is also useful if the stream control unit 103 receives the content of the user operation from the user operation input unit 102 and determines the type of the user operation.

In step S306, the user operation input unit 102 transmits, to the viewing configuration storage unit 1031, information about the viewing configuration input in step S304 and set based on the viewing configuration selection operation by the user.

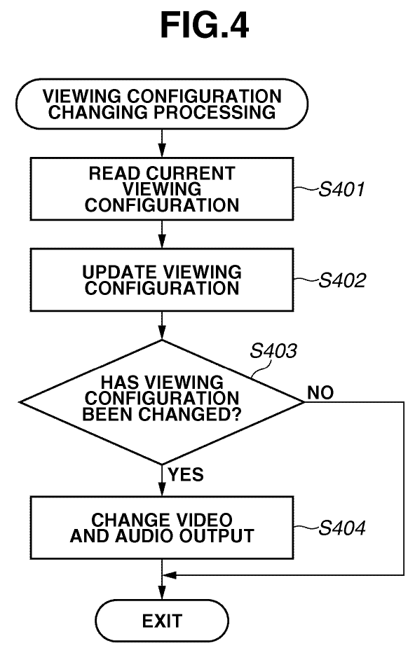

Then, the viewing configuration storage unit 1031 changes the stored viewing configuration (elementary stream to be viewed) according to the information about the viewing configuration received from the user operation input unit 102. The processing in step S306 will be described in detail below with reference to FIG. 4.

On the other hand, if it is determined in step S305 that the type of the user operation is the additional command, then the following processing is performed.

In step S308, the user operation input unit 102 transmits the content of the additional command input in step S304 to the user command execution unit 1033. Furthermore, the user command execution unit 1033 determines the type of the additional command received from the user operation input unit 102.

If it is determined in step S308 that the additional command is the command for extracting the search keyword, then the processing advances to step S309. On the other hand, if it is determined in step S308 that the additional command is the command for executing the one-touch recording, then the processing advances to step S310.

On the other hand, if it is determined in step S308 that the additional command is a command other than those described above, then the processing advances to step S311.

The processing performed in steps S309 through step S311 will be described in detail later below with reference to a detailed configuration of the user command execution unit 1033 and the flow chart illustrated in FIG. 3.

In step S312, processing for powering off the digital television set 100 is performed. The processing for powering off the digital television set 100 includes various control operations to be executed when the digital television set 100 is powered off.

For example, in this case, the data stored on a buffer area of the receiving and separation unit 101 and the user operation input unit 102 is deallocated. Furthermore, the default broadcast program and the viewing configuration to be utilized when the digital television set 100 is powered on the next time are stored.

In the present exemplary embodiment, in step S312, the digital television set 100 is powered off and the processing in steps S309 through S311 that has been performed according to the additional command end. However, it is also useful if the processing does not end at this timing.

More specifically, it is also useful if the processing by the receiving and separation unit 101 and the stream control unit 103 is continued to continue the recording processing even when the digital television set 100 is powered off during the one-touch recording of the broadcast program and thus the reproduction of the broadcast program is discontinued.

Now, processing for changing the viewing configuration (the elementary stream to be viewed) performed based on the operation for selecting the viewing configuration by the user will be described below with reference to FIG. 4.

FIG. 4 is a flow chart illustrating the details of the processing for changing the viewing configuration stored on the viewing configuration storage unit 1031. The processing illustrated in FIG. 4 corresponds to the processing in step S306 in FIG. 3.

The digital television set 100 according to the present exemplary embodiment executes the operation of the stream control unit 103 (each of the viewing configuration storage unit 1031, the user command execution unit 1033, and the blending unit 1032) with the software stored on the digital television set 100. That is, the CPU that controls the entire operation of the digital television set 100 reads and executes the control program from the ROM to execute the processing.

After receiving information about the viewing configuration designated by the viewing configuration selection operation by the user, which has been transmitted from the user operation input unit 102, the processing illustrated in FIG. 4 starts. Referring to FIG. 4, in step S401, the viewing configuration storage unit 1031 reads the current viewing configuration. Then, the processing advances to step S402.

The following description is made supposing that the viewing configuration storage unit 1031 has read the viewing configuration A (FIG. 2A).

In step S402, the CPU of the digital television set 100 updates the viewing configuration stored on the viewing configuration storage unit 1031 based on the information about the viewing configuration received from the user operation input unit 102. In the present exemplary embodiment, it is supposed that the user has pressed a datacasting ON/OFF button in the state of the viewing configuration A (FIG. 2A).

In this case, the current viewing configuration of the datacasting ES read in step S401 has been set to the parameter value “0” (not to be reproduced). Accordingly, the CPU of the digital television set 100 changes the parameter value to “1” (to be reproduced). As a result, the viewing configuration is changed from the viewing configuration A to the viewing configuration B (FIG. 2B).

In step S403, the CPU of the digital television set 100 determines whether the viewing configuration stored on the viewing configuration storage unit 1031 has been changed in step S402.

If it is determined in step S403 that the viewing configuration stored on the viewing configuration storage unit 1031 has been changed in step S402 (YES in step S403), then the processing advances to step S404. On the other hand, if it is determined in step S403 that the viewing configuration stored on the viewing configuration storage unit 1031 has not been changed in step S402 (NO in step S403), then the processing for changing the viewing configuration ends.

In the present exemplary embodiment, the viewing configuration A has been changed to the viewing configuration B. Accordingly, the processing advances to step S404.

In step S404, the viewing configuration storage unit 1031 notifies the blending unit 1032 that the viewing configuration has been changed to the viewing configuration B.

Furthermore, the blending unit 1032 changes the video output and the audio output based on the notified change in the viewing configuration and outputs new video and audio data to the reproduction unit 104.

Furthermore, in addition to performing the above-described viewing configuration changing processing, the CPU of the digital television set 100 changes the data to be recorded in the above-described processing on the additional command.

That is, the content data output by the blending unit 1032 and the target of recording (data to be recorded) by the user command execution unit 1033 are changed accordingly as the content data (elementary stream) to be output by the viewing configuration storage unit 1031 is changed as described above.

In the example illustrated in FIGS. 2A through 2C, since the datacasting indicated in the row 2b12 has been newly set in the viewing configuration, the blending unit 1032 receives two elementary streams (the video 1 and the datacasting) as a video source. Furthermore, the blending unit 1032 blends the video 1 and the datacasting. As a result, the reproduction unit 104 reproduces a video 2b01.

Furthermore, because the viewing configuration of the audio source has not been changed between the viewing configuration A and the viewing configuration B, the audio data reproduced by a speaker 2b02 is the same as that reproduced by the speaker 2a02.

Meanwhile, suppose that the change in the viewing configuration of a plurality of elementary streams is calculated in step S402 according to one operation for selecting the viewing state received in step S304 (FIG. 3).

In this regard, if the viewing configuration storage unit 1031 has received the operation for changing the type of the audio between the main audio and the sub audio in step S304 in the state of the viewing configuration B (FIG. 2B), then the viewing configuration of the main audio indicated in the row 2c08 (FIG. 2B) is changed to “0” (not to be reproduced) and the viewing configuration of the sub audio indicated in the row 2c09 is changed to “1” (to be reproduced) as a result of the processing in step S402.

Furthermore, consequently, the audio data output by the reproduction unit 104 is changed to the sub audio. Furthermore, in this case, the viewing configuration is changed from the viewing configuration B to the viewing configuration C illustrated in FIG. 2C.

Note here that the viewing configuration may not be changed even in the case where the viewing configuration storage unit 1031 has received the operation for selecting (changing) the viewing configuration in step S304 (FIG. 3) if the user inputs the operation for changing the audio between the main audio and the sub audio with respect to a broadcast program that includes only one audio ES.

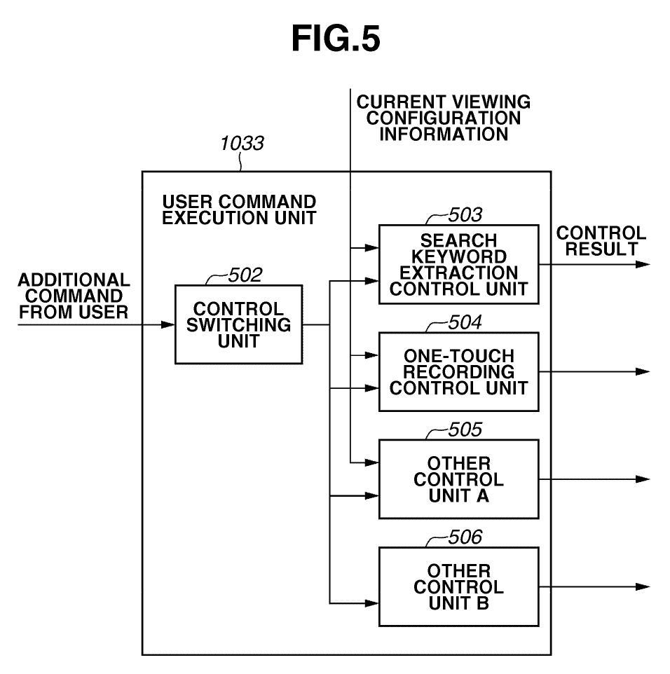

Now, processing performed in the case where the user has input an additional command from the user operation input unit 102 will be described in detail below with reference to FIG. 5.

FIG. 5 illustrates an exemplary module configuration of the user command execution unit 1033 that performs the processing based on the additional command from the user.

Note that the digital television set 100 of the present exemplary embodiment, as described above, operates the stream control unit 103, more specifically, each of the viewing configuration storage unit 1031, the user command execution unit 1033, and the blending unit 1032 by the software stored on the digital television set 100.

That is, the CPU that executes each control by the digital television set 100 reads the control program stored on the ROM and executes the processing.

A control switching unit 502 determines the type of the additional command input by the user via the user operation input unit 102 and switches the processing to be performed differently with respect to each type of additional command. The control switching unit 502 selects the content data (elementary stream) to be output to the reproduction unit 104 from among a plurality of pieces of content data (elementary streams) received by the tuner unit 1011.

If it is determined by the control switching unit 502 that the additional command is the command for extracting the search keyword, then the control switching unit 502 requests the search keyword extraction control unit 503 to perform the subsequent processing for extracting a search keyword.

On the other hand, if it is determined by the control switching unit 502 that the additional command is the command for executing the one-touch recording, then the control switching unit 502 requests the one-touch recording control unit 504 to perform the subsequent processing for executing the one-touch recording function. As described above, the user command execution unit 1033 includes the control units corresponding to each of the additional commands that can be controlled by the digital television set 100.

In the example illustrated in FIG. 5, the user command execution unit 1033 includes four controls units (the search keyword extraction control unit 503, the one-touch recording control unit 504, other control unit A 505, and other control unit B 506). The control units 503 through 506 correspond to different additional commands.

Among the four control units 503 through 506 of the user command execution unit 1033 illustrated in FIG. 5, the control units 503 through 505 uses the information about the viewing configuration to execute the processing, while the another control unit 506 executes the processing based on the additional command for executing the processing without using the current viewing configuration among the additional commands input from the user operation input unit 102.

As an example of the additional command for performing the processing without using the current viewing configuration, the command for setting an off timer for the digital television set 100 or a command for reproducing two broadcast programs can be issued.

The result of the processing executed by the control units 503 through 506 is reproduced by the reproduction unit 104 as a video output and an audio output via the blending unit 1032 as necessary.

The search keyword extraction control unit 503 selects the content data that is currently being reproduced by the reproduction unit 104 as the target of searching for the search keyword. Furthermore, the one-touch recording control unit 504 selects the content data that is currently being reproduced by the reproduction unit 104 as the recording target data. The details of the processing by the search keyword extraction control unit 503 and the one-touch recording control unit 504 will be described in detail below.

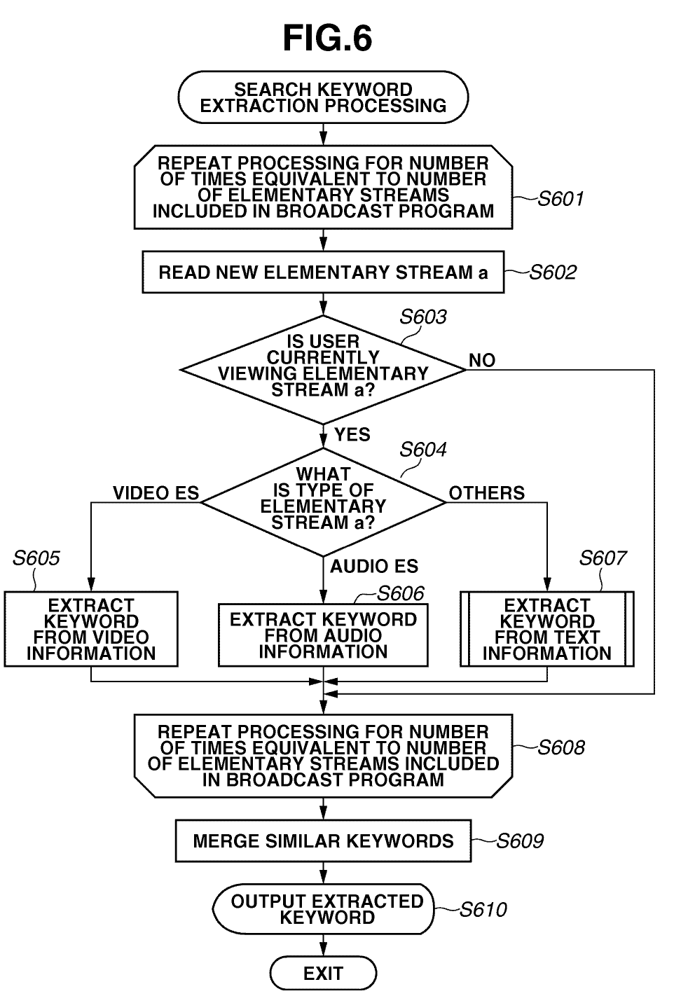

Now, an exemplary flow of processing for extracting the search keyword will be described in detail below with reference to FIG. 6.

FIG. 6 is a flow chart illustrating the details of exemplary processing for extracting the search keyword executed by the search keyword extraction control unit 503 of the user command execution unit 1033 according to the present exemplary embodiment.

The digital television set 100 according to the present exemplary embodiment executes the operation of the stream control unit 103 (each of the viewing configuration storage unit 1031, the user command execution unit 1033, and the blending unit 1032) with the software stored on the digital television set 100.

That is, the CPU that executes each control by the digital television set 100 reads the control program stored on the ROM and executes the processing.

Referring to FIG. 6, steps S601 and S608 indicate that the processing in steps S601 through S608 is repeatedly executed for the number of times equivalent to the number of elementary streams included in the selected broadcast program.

In the example illustrated in FIGS. 2A through 2C, seven elementary streams are registered in each viewing configuration. Accordingly, the frequency of repeating the processing is 7.

In step S602, the search keyword extraction control unit 503 extracts one new elementary stream from the viewing configuration stored on the viewing configuration storage unit 1031. In the present exemplary embodiment, the description is made supposing that the viewing configuration B illustrated in FIG. 2B has been stored and a datacasting ES 2b12 has been selected as a new elementary stream.

In step S603 (second selection processing), the search keyword extraction control unit 503 determines whether the elementary stream acquired in step S602 is currently being viewed.

That is, the search keyword extraction control unit 503 determines the current viewing state according to the current viewing state 2a05 of the elementary stream stored on the viewing configuration storage unit 1031.

If it is determined in step S603 that the elementary stream acquired in step S602 is currently being viewed (YES in step S603), then the processing advances to step S604. On the other hand, if it is determined in step S604 that the elementary stream acquired in step S602 is not currently being viewed (NO in step S604), then the processing advances to step S608. In this case, then the processing returns to step S601.

That is, the search keyword extraction control unit 503 selects the content data (elementary stream) that is currently being output by the blending unit 1032 as the target of recording.

In the example illustrated in FIG. 6, the current viewing state of the datacasting ES 2b12 is “1” (to be reproduced). Accordingly, the search keyword extraction control unit 503 determines that the datacasting 2b12 is a currently viewed elementary stream. Then, the processing advances to step S604.

In step S604, the search keyword extraction control unit 503 determines the type of the elementary stream acquired in step S602.

If it is determined in step S604 that the type of the elementary stream acquired in step S602 is the video ES, then the processing advances to step S605. On the other hand, if it is determined in step S604 that the type of the elementary stream acquired in step S602 is the audio ES, then the processing advances to step S606. If it is determined in step S604 that the type of the elementary stream acquired in step S602 is none of those described above, then the processing advances to step S607.

In the example illustrated in FIG. 6, it is determined that the datacasting ES 2b12 is the ES other than those described above. Then, the processing advances to step S607.

In step S605, the search keyword extraction control unit 503 extracts the search keyword from the video information included in the video ES. As a method for extracting the keyword from the video information, a method for acquiring a text string in a flip in the video by image recognition and extracting a keyword from the acquired text string can be used.

In the present exemplary embodiment, the search keyword is extracted from the video ES output from the blending unit 1032 during a predetermined time period after the extraction of the search keyword is instructed. However, the present invention is not limited to this.

That is, it is also useful if the search keyword is extracted from a video ES output during a time period from the time the extraction of the search keyword is instructed to the time the ending of the search keyword extraction is instructed. Furthermore, it is also useful if the search keyword is extracted from the video ES output during a time period until the broadcast program that is currently viewed at the time the instruction is received ends.

Furthermore, the video ES output previous to the instruction for extracting the search keyword by a predetermined length of time can be included in the target of searching for the search keyword.

In step S606, the search keyword extraction control unit 503 extracts the search keyword from the audio information included in the audio ES. As a method for extracting the keyword from the audio information, a method can be used that recognizes and identifies the voice of a person and extracts a search keyword from a text string acquired by the voice recognition.

In the present exemplary embodiment, the search keyword is extracted from the audio ES output from the blending unit 1032 during a predetermined time period after the extraction of the search keyword is instructed. However, the present invention is not limited to this.

That is, it is also useful if the search keyword is extracted from an audio ES output during a time period from the time the extraction of the search keyword is instructed to the time the ending of the search keyword extraction is instructed. Furthermore, it is also useful if the search keyword is extracted from the audio ES output during a time period until the broadcast program that is currently viewed at the time the instruction is received ends.

Furthermore, the audio ES output previous to the instruction for extracting the search keyword by a predetermined length of time can be included in the target of searching for the search keyword.

In step S607, the search keyword extraction control unit 503 extracts the search keyword from the text information included in the other elementary stream.

As the other elementary stream, a subtitle, a caption, and a datacasting, for example, can be used. Most of the elementary streams previously store the text information. That is, the search keyword extraction control unit 503 extracts the text information from the elementary stream, such as the subtitle, the caption, or the datacasting, for example.

Furthermore, the present exemplary embodiment divides the extracted text information into keywords by using a publicly known method such as parsing. Then, the keywords that may be considered effective and useful as the search keywords are extracted.

In the present exemplary embodiment, similar to the processing on the video and the audio data, the search keyword is extracted from the text information output from the blending unit 1032 during a predetermined time period after receiving the search keyword extraction instruction. However, the present exemplary embodiment is not limited to this.

That is, it is also useful if the search keyword is extracted from text information output during a time period from the time the extraction of the search keyword is instructed to the time the ending of the search keyword extraction is instructed. Furthermore, it is also useful if the search keyword is extracted from the text information output during a time period until the broadcast program that is currently viewed at the time the instruction is received ends.

Furthermore, the text information output previous to the instruction for extracting the search keyword by a predetermined length of time can be included in the target of searching for the search keyword.

In step S609, the search keywords that have been extracted thus far are merged. If keywords similar to one another are extracted, the similar keywords are compiled.

In the viewing configuration B (FIG. 2B), three elementary streams, namely, the video 1, the main audio, and the datacasting, of the seven elementary streams, are currently viewed elementary streams. Accordingly, the search keywords extracted in steps S605, 606, and 607 are merged from the elementary streams, and the similar keywords are compiled.

In step S610, the user command execution unit 1033 transmits a list of the search keywords generated in step S609 to the blending unit 1032.

Then, the blending unit 1032 outputs a result of blending the search keyword list received from the user command execution unit 1033 and the currently viewed video to the reproduction unit 104. With respect to the method of outputting by the blending unit 1032, a method can be used that displays a list of all merged search keywords. Alternatively, another method can be used that displays only the search keywords whose frequency of appearance is relatively high. Furthermore, it is also useful if a result of further filtering executed by using information about favorite categories, which is previously registered by the user.

Furthermore, the user command execution unit 1033 records the search keyword gathered up in step S609 on a recording unit (not illustrated) in step S610.

More specifically, the recording unit records the search keyword extracted from the content data (elementary stream) based on the selection performed by the user command execution unit 1033.

Now, particular processing for extracting the keyword from the text information, of exemplary processing for extracting the search keyword executed by the search keyword extraction control unit 503 of the user command execution unit 1033 will be described in detail below. The processing for extracting the keyword from the text information corresponds to the processing in step S607 (FIG. 6).

In this regard, at first, the search keyword extraction control unit 503 extracts the text information from the elementary stream such as a subtitle, a caption, and a datacasting.

Then, the search keyword extraction control unit 503 divides the extracted text information into keywords by using a publicly known method such as parsing. Then, the keywords that may be considered effective and useful as the search keywords are extracted.

By performing the above-described exemplary processing for extracting the search keyword, the present exemplary embodiment extracts the search keyword from the elementary stream included in the current viewing configuration. Accordingly, the present exemplary embodiment can extract the search keyword while preventing the extraction of the unnecessary keyword that may otherwise occur.

In addition, by performing the above-described exemplary processing, the present exemplary embodiment can prevent the extraction of a search keyword from the audio data (linguistic information) that the user does not consider necessary in the case where the user is currently viewing a broadcast program for which foreign language data is allocated to the main audio thereof and translation data thereof is allocated to the sub audio, for example.

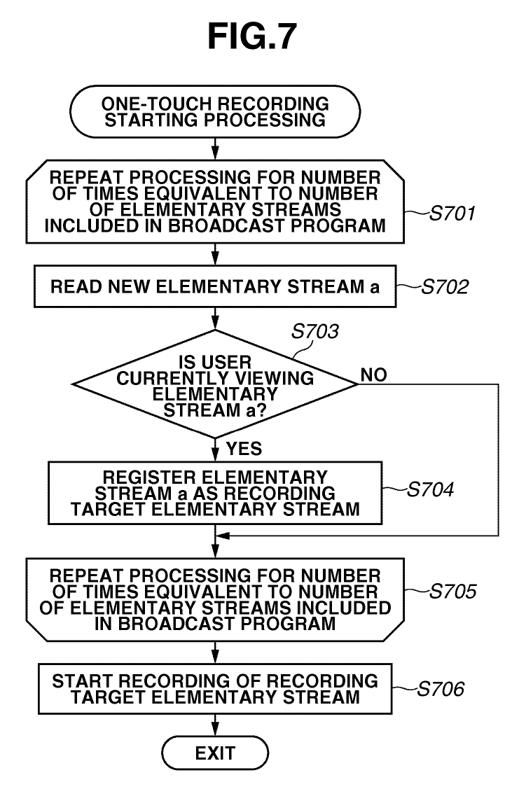

Now, the one-touch recording performed by the one-touch recording control unit 504 (FIG. 5) will be described in detail below with reference to FIG. 7.

FIG. 7 is a flow chart illustrating an exemplary flow of the processing for executing the one-touch recording by the one-touch recording control unit 504 of the user command execution unit 1033. The processing illustrated in FIG. 7 corresponds to the processing in step S310 of FIG. 3.

Referring to FIG. 7, steps S701 and S705 indicate that the processing in steps S701 through S705 is repeatedly executed for the number of times equivalent to the number of elementary streams included in the broadcast program. In the present exemplary embodiment, seven elementary streams are registered with respect to one broadcast program in the viewing configuration storage unit 1031. Accordingly, the frequency of repeating the processing is 7.

In step S702, the one-touch recording control unit 504 extracts one new elementary stream. That is, the one-touch recording control unit 504 extracts one elementary stream from among a plurality of elementary streams registered with respect to the broadcast program according to the information about the PID stored on the viewing configuration storage unit 1031.

In the present exemplary embodiment, the following description will be made supposing that the viewing configuration B (FIG. 2B) is stored as the current viewing configuration and that the user has selected the datacasting 2b12 as the new elementary stream.

In step S703 (second selection processing), the one-touch recording control unit 504 determines whether the elementary stream acquired in step S702 is currently being viewed.

That is, the one-touch recording control unit 504 determines whether the elementary stream acquired in step S702 is currently being viewed by referring to the information about the current viewing state 2a05 stored on the viewing configuration storage unit 1031.

If it is determined in step S703 that the elementary stream acquired in step S702 is currently being viewed (YES in step S703), then the processing advances to step S704. On the other hand, if it is determined in step S703 that the elementary stream acquired in step S702 is not currently being viewed (NO in step S703), then the processing proceeds to step S705. In the example illustrated in FIG. 7, the one-touch recording control unit 504 determines that the datacasting 2b12 is the currently viewed elementary stream. Then, the processing advances to step S704.

That is, the one-touch recording control unit 504 determines whether the elementary stream (content data) is the elementary stream that is currently being output to the reproduction unit 104 by accessing the viewing configuration storage unit 1031.

In step S704, the one-touch recording control unit 504 registers the elementary stream that has been selected as the elementary stream to be recorded in step S702. In the example illustrated in FIG. 7, the datacasting 2b12 is registered as the elementary stream to be recorded.

In the present exemplary embodiment, the video 1 and the main audio are registered as the recording target elementary stream in step S704 as well as the datacasting 2b12. That is, the one-touch recording control unit 504 selects the content data currently being output (the elementary stream) by the blending unit 1032 to the reproduction unit 104 as the target of recording.

In step S706, the one-touch recording control unit 504 starts recording the elementary stream that has been registered as the elementary stream to be recorded so far on the recording unit (not illustrated).

In the viewing configuration B (FIG. 2B), three elementary streams, namely, the video 1, the main audio, and the datacasting, of the seven elementary streams, have been determined as currently viewed elementary streams. Accordingly, the one-touch recording control unit 504 starts recording the elementary streams.

Note that in recording the ES, various other configurations than that described above can be used according to the combination of the type of a recording medium and the type of the recording format.

In addition, as described above, it is also useful if the one-touch recording control unit 504 temporarily records all of the elementary streams multiplexed in the broadcast program and deletes the data of the elementary stream that is not currently being viewed from the recorded elementary stream. That is, the one-touch recording control unit 504 records the content data (elementary stream) on the recording unit according to the selection in step S704.

By performing the above-described processing, the present exemplary embodiment can reduce the capacity of the storage area necessary to be secured for executing the one-touch recording on the broadcast program including a plurality of pieces of video data, such as a multiview broadcast.

The present invention having the above-described configuration performs, on the limited type of stream data only, the processing to be performed on the additional command executed by using the information about the actually and currently being viewed stream data.

With the above-described configuration, the present invention can efficiently perform the processing executed based on the additional command for the broadcast program in which a plurality of pieces of content data (elementary stream) has been multiplexed.

In addition, the present invention can prevent the extraction of an unnecessary keyword or the increase in the processing amount, which may otherwise occur in the case where the additional command is the search keyword extraction command.

Furthermore, in the case where the additional command from the user is the command for executing the one-touch recording operation, the present exemplary embodiment can reduce the capacity of the storage area necessary for recording by limiting the elementary stream to be recorded according to the viewing configuration.

Now, a second exemplary embodiment of the present invention will be described in detail below by focusing on points of difference from the first exemplary embodiment.

In the present exemplary embodiment, when the user operation input unit 102 receives the user input in step S304, the user operation input unit 102 receives information about whether to use the viewing configuration stored on the viewing configuration storage unit 1031 as well.

The information about whether to use the received viewing configuration is transmitted to the control units 503 through 506 of the user command execution unit 1033. The information is used by each of the control units 503 through 506 to perform the control thereof.

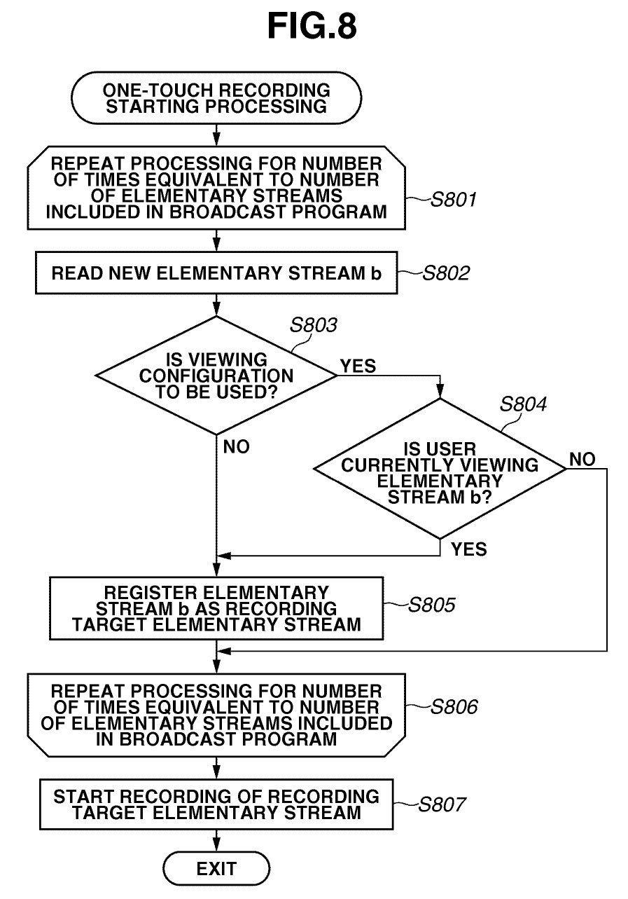

Now, an operation performed in the case where the additional command is the command for executing the one-touch recording according to the present exemplary embodiment will be described in detail below with reference to FIG. 8.

FIG. 8 is a flow chart illustrating the details of the one-touch recording processing executed by the one-touch recording control unit 504 of the user command execution unit 1033 according to the second exemplary embodiment.

Note here that the digital television set 100 according to the present exemplary embodiment executes the operation of the stream control unit 103 (each of the viewing configuration storage unit 1031, the user command execution unit 1033, and the blending unit 1032) with the software stored on the digital television set 100.

That is, a central processing unit (CPU) that controls the entire operation of the digital television set 100 reads and executes the control program from a read-only memory (an ROM) to execute the processing. However, it is also useful if the processing performed by the above-described components is executed by dedicated hardware.

Referring to FIG. 8, step S801 and step S806 indicate that the processing in steps S801 through S806 is repeatedly executed for the number of times equivalent to the number of elementary streams included in the selected broadcast program.

In step S802, the one-touch recording control unit 504 extracts one elementary stream from the viewing configuration stored on the viewing configuration storage unit 1031.

In step S803, the one-touch recording control unit 504 determines whether the viewing configuration is to be used to execute the processing.

That is, the one-touch recording control unit 504 determines whether the viewing configuration is to be used to execute the processing based on the information about whether to use the viewing configuration, which has been received at the same time as the one-touch recording execution command.

As it may become apparent by comparing the example illustrated in FIG. 7 and that illustrated in FIG. 8, the second exemplary embodiment is different from the first exemplary embodiment in a point that the processing in step S803 is added to the processing performed in the first exemplary embodiment.

If it is determined in step S803 that the received viewing configuration is to be used (YES in step S803), then the processing advances to step S804. On the other hand, if it is determined in step S803 that the viewing configuration is not to be used (NO in step S803), then the processing advances to step S805.

With the above-described configuration, the present exemplary embodiment can set all of the elementary streams multiplexed in the broadcast program as the control target elementary stream if the information indicating that the viewing configuration is not to be used has been received at the same time as the additional command from the user.

In step S804, the one-touch recording control unit 504 determines whether the elementary stream acquired in step S802 is currently being viewed.

If it is determined in step S804 that the elementary stream acquired in step S802 is currently being viewed (YES in step S804), then the processing advances to step S805. On the other hand, if it is determined in step S804 that the elementary stream acquired in step S802 is not currently being viewed (NO in step S804), then the processing advances to step S806 before returning to step S801.

In step S805, the one-touch recording control unit 504 registers the elementary stream selected in step S802 as the elementary stream to be recorded.

In step S807, the one-touch recording control unit 504 starts recording the elementary stream that has been registered as the elementary stream to be recorded so far on the recording unit. Then, the recording unit records the content data (elementary stream) according to the selection by the one-touch recording control unit 504 in step S805.

With the above-described configuration, the present exemplary embodiment can implement and execute the processing on all of the elementary streams, which are set as control targets, in the case where the information instructing that the viewing configuration is not to be used is received at the same time as the additional command is input.

The processing flow can be sharedly used by (applied to all of the control units 503 through 506 of the user command execution unit 1033. More specifically, the processing flow can be utilized in the case of executing other control operations such as the extraction of search keyword.

Furthermore, the present invention can be alternatively implemented by implementing both the first and the second exemplary embodiments on the same digital television set 100 and causing the digital television set 100 to operate by appropriately shifting its operation mode as necessary.

Now, a third exemplary embodiment of the present invention will be described in detail below focusing on points of difference from the first exemplary embodiment.

The viewing configuration storage unit 1031 according to the present exemplary embodiment stores a history-added viewing state including the information about the stream data that has been previously viewed. The history-added viewing state is used for determining whether to set a specific elementary stream as the control target in performing each control on the additional command.

That is, the viewing configuration storage unit 1031 associates the identification information (PID) of the content data (elementary stream) that has been output by the blending unit 1032 thus far with attribute information (the history-added viewing state) thereof and stores the mutually associated identification information and the attribute information.

Note here that the identification information of the elementary stream is not limited to the PID. That is, a component tag or identification information uniquely allocated by the digital television set 100 can be used as the identification information of the elementary stream.

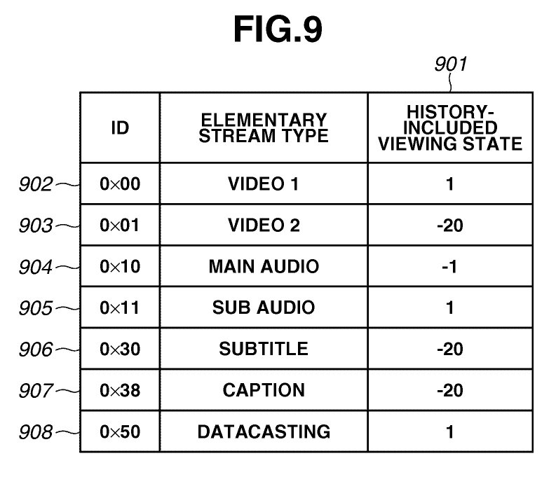

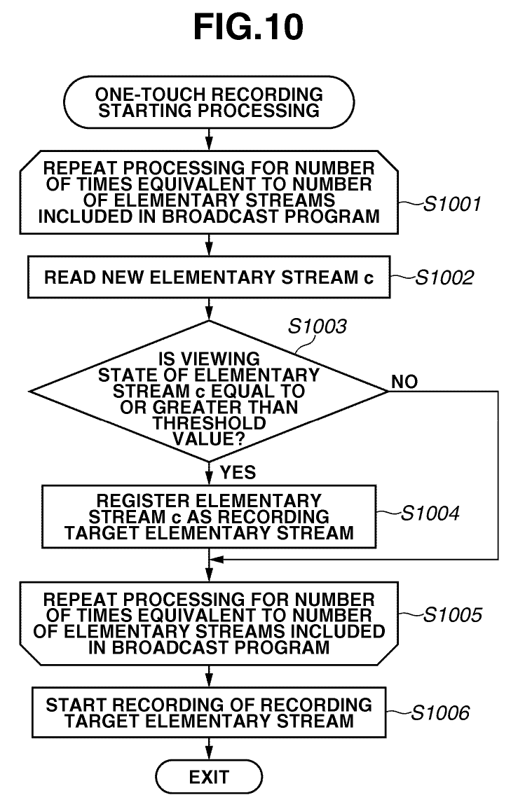

Now, an operation of the digital television set 100 according to the present exemplary embodiment will be described in detail below with reference to FIGS. 9 and 10.

FIG. 9 illustrates an example of the information about the viewing configuration stored on the viewing configuration storage unit 1031. Referring to FIG. 9, a column 901 indicates the history-added viewing state.

In the present exemplary embodiment, the currently viewed elementary stream is allocated with the parameter value “1” (to be reproduced) while the elementary stream that is not currently viewed is allocated with a negative value according to the length of time that has elapsed since the last time the elementary stream was viewed. In particular, with respect to the elementary stream that is not currently being viewed, the present exemplary embodiment executes the processing so that the value allocated to the elementary stream that is not currently being viewed is decremented at the elapse of a predetermined length of time. Therefore, the longer the above-described elapsed time of the elementary stream is, the smaller the value to be allocated thereto becomes. In the example illustrated in FIG. 9, rows 902, 905, and 908 indicate currently viewed elementary streams. A row 904 indicates an elementary stream that is not currently being viewed but has been viewed until the time immediately before the user has started viewing the currently viewed elementary stream.

A parameter value “−20” stored in rows 903, 906, and 907 indicates that the corresponding elementary stream is an elementary stream whose time elapsed since the last viewing is longer than a predetermined length of time. In this regard, in the case where the history-added viewing state is decremented every twenty-four hours after the end of the elementary stream, the history-added viewing state is set at “0” after one whole day has passed. Therefore, if twenty-one days has passed, the parameter value “−20” is set, which is a lower limit value for the history-added viewing state.

When the user starts viewing the elementary stream, the history-added viewing state is set at “1”, which is set regardless of the value that has been set before the viewing was started.

As described above, the history-added viewing state information is information about the time elapsed since the time the output by the blending unit 1032 has been performed.

Furthermore, processing performed in the case where the additional command is the one-touch recording execution command will be described in detail below with reference to FIG. 10.

FIG. 10 is a flow chart illustrating the details of the processing for executing the one-touch recording by the one-touch recording control unit 504 of the user command execution unit 1033.

The digital television set 100 according to the present exemplary embodiment executes the operation of the stream control unit 103 (each of the viewing configuration storage unit 1031, the user command execution unit 1033, and the blending unit 1032) with the software stored on the digital television set 100. That is, the CPU that executes each control by the digital television set 100 reads the control program stored on the ROM and executes the processing.

However, it is also useful if the processing performed by the above-described components is executed by dedicated hardware.

Referring to FIG. 10, steps S1001 and S1005 indicate that the processing in steps S1001 through S1005 is repeatedly executed for the number of times equivalent to the number of elementary streams included in the selected broadcast program.

In the example illustrated in FIG. 10, seven elementary streams are registered in each viewing configuration. Accordingly, the frequency of repeating the processing is 7.

In step S1002, the one-touch recording control unit 504 extracts one new elementary stream from the information about the viewing configuration stored on the viewing configuration storage unit 1031.

That is, the one-touch recording control unit 504 extracts one elementary stream from among the elementary streams multiplexed in the broadcast program according to the information included in the PID stored on the viewing configuration storage unit 1031.

The following description is made supposing that a main audio 1004 has been selected as a new elementary stream in the example illustrated in FIG. 10.

Note that as described above, the information for identifying the elementary stream is not limited to the PID. In this regard, a component tag or an ID allocated by the digital television set 100, for example, can be used.

In step S1003, the one-touch recording control unit 504 determines whether the viewing state of the elementary stream acquired in step S1002 is equal to or greater than a threshold value (e.g., “−5”).

That is, the one-touch recording control unit 504 refers to the viewing configuration storage unit 1031 and determines whether the history-added viewing state of the elementary stream extracted in step S1002 is equal to or greater than the predetermined threshold value.

If it is determined in step S1003 that the history-added viewing state of the elementary stream extracted in step S1002 is equal to or greater than the predetermined threshold value (YES in step S1003), then the processing advances to step S1004. On the other hand, if it is determined in step S1003 that the history-added viewing state of the elementary stream extracted in step S1003 is less than the predetermined threshold value (NO in step S1003), then the processing advances to step S1005 before returning to step S1001.

The threshold value is set by an input by the user via the operation input unit 102. However, in the case where the user does not input any setting, a previously set default threshold value can be used. In this regard, a value “−5” is set as the threshold value.

In the example illustrated in FIG. 10, the value “−1” is set as the history-added viewing state of the main audio 904, which has been extracted in step S1002. Accordingly, the processing advances to step S1004.

In step S1004, the user command execution unit 1033 registers the elementary stream selected in step S1002 as the elementary stream to be recorded.

In the example illustrated in FIG. 10, the main audio 1004 is registered as the elementary stream to be recorded. That is, the user command execution unit 1033 selects the content data (elementary stream) to be recorded based on the identification information (PID) and the attribute information (the history-added viewing state) stored on the viewing configuration storage unit 1031.

By performing the above-described processing, the present exemplary embodiment can select the previously viewed elementary stream as the target of recording. Accordingly, the present exemplary embodiment can prevent the failure to record the data necessary for the user.

Note that the viewing configuration storage unit 1031 according to the present exemplary embodiment stores, as the history-added viewing state, the value set by decrementing the same with a predetermined time interval from the time of last viewing of each elementary stream.

Furthermore, the user command execution unit 1033 selects the elementary stream to be selected as the recording target elementary stream based on the threshold value, which has been previously designated at the time of receiving the additional command. However, the present invention is not limited to this.

That is, it is also useful if the following processing is performed. In this regard, the user previously sets the time period for storing and holding the previous viewing state and the viewing configuration storage unit 1031 sets the parameter value “0” for the viewing state of the elementary stream longer than the time period that has been set by the user.

Furthermore, the user command execution unit 1033 selects the elementary stream whose history-added viewing state is not set at “0” (not to be reproduced), of the elementary streams stored on the viewing configuration storage unit 1031, as the target of recording.

In this regard, if the user has set a parameter value “one month” as the time period for applying the previous viewing state to the additional command, the parameter value “1” (to be reproduced) is set for the viewing state of the currently viewed elementary stream and the elementary stream that has been viewed within one month from the current date and time. Furthermore, in this case, the parameter value “0” (not to be reproduced) is set for the viewing state of the elementary stream that has not been viewed for more than one month.

With the above-described configuration, the present exemplary embodiment can save the user from taking much trouble in the case of processing the additional command.

Furthermore, it is also useful if the following configuration is employed. That is, a parameter value “1” (to be reproduced) is set for the viewing state of the currently viewed elementary stream while a parameter value “0” (not to be reproduced) is set for the viewing state of the elementary stream that has not been viewed for more than one month.

In addition, in this case, the viewing state of the stream that has been viewed within one month from the current date and time can be set according to the time period of the last viewing.

Furthermore, in this case, the user can issue an additional command with respect to the elementary stream that the user has viewed within one week from the current date and time, for example.

With the above-described configuration, the present exemplary embodiment can efficiently manage the information about the viewing state of the elementary stream that has not been viewed for more than one month.

In step S1006, the user command execution unit 1033 starts recording the elementary stream that has been registered as the recording target elementary stream on the recording unit.

In the present exemplary embodiment, it is determined that four elementary streams of the seven elementary streams, namely, the video 1, the main audio, the sub audio, and the datacasting, are the elementary streams whose above-described parameter value is equal to or greater than the predetermined threshold value. Accordingly, the recording of the elementary streams is started at this timing.

As described above, the present exemplary embodiment sets the history-added viewing state together with the current viewing configuration and selects the elementary stream to be controlled based on the current viewing configuration and the history-added viewing state set in the above-described manner.

With the above-described configuration, the present exemplary embodiment can select the elementary stream that has been previously viewed. Accordingly, the present exemplary embodiment can prevent the failure of recording the data necessary for the user.

That is, in performing the one-touch recording, the present exemplary embodiment can select the elementary stream that has been previously viewed and is likely to be viewed again later as the recording target elementary stream as well as the currently viewed elementary stream.

In the present exemplary embodiment, the viewing configuration storage unit 1031 stores the identification information and the viewing state of all of the elementary streams that have been multiplexed in the broadcast program. However, the present invention is not limited to this. That is, it is also useful if the viewing configuration storage unit 1031 does not store the information about the elementary stream that has never been viewed so far.

In addition, it is also useful if, with respect to an elementary stream whose time elapsed since the last viewing thereof has exceeded a predetermined threshold value, the information about the above-described elementary stream is deleted from the viewing configuration storage unit 1031.

More specifically, in this case, the viewing configuration storage unit 1031 associates the identification information (PID) and the attribute information (history-added viewing state) of the identification information of the content data (elementary stream) that has been output by the blending unit 1032 so far and stores the mutually associated identification information and the attribute information of the identification information. Furthermore, the viewing configuration storage unit 1031 deletes the identification information of the content data stored thus far based on the attribute information.

As described above, the present exemplary embodiment can reduce the number of repeating the processing performed on the additional command by deleting the identification information of the elementary stream that has never been viewed.

In addition, in the present exemplary embodiment, it is also useful if the information about the elementary stream of a specific broadcast program that has been previously viewed is used in the processing for selecting an elementary stream of another broadcast program.

More specifically, suppose here that the user has viewed the elementary stream of a video including Japanese subtitles and a video including English subtitles, among elementary streams included in a specific broadcast program (a program 1) that has been previously viewed. Furthermore, suppose here that the user has viewed an elementary stream including English subtitles and an elementary stream including Spanish subtitles among elementary streams included in another broadcast program (a broadcast program 2) that has been previously viewed.

In addition, in the case where a currently viewed broadcast program (a broadcast program 3) includes elementary streams of videos including multilingual subtitles, such as Japanese, English, Spanish, and French subtitles, the viewing configuration storage unit 1031 selects the elementary streams of the videos including Japanese, English, and Spanish subtitles, among the above-described elementary streams including multilingual subtitles, as the recording target elementary stream.

With the above-described configuration, in the case of executing the one-touch recording, the present exemplary embodiment can record the elementary stream likely to be viewed by the user while preventing the recording of the elementary stream that is not likely to be viewed.

Furthermore, it is also useful if whether to select an elementary stream as the recording target elementary stream is determined according to the time elapsed since the time another broadcast program was viewed.

More specifically, suppose here that one month or more has elapsed since the elementary stream of the videos including Japanese subtitles and English subtitles of the broadcast program 1 was viewed the last time (and that less than one month has elapsed since the elementary stream of the videos including English subtitles and Spanish subtitles of the broadcast program 2 was viewed the last time). In this case, it is also useful if the viewing configuration storage unit 1031 selects only the elementary streams including English subtitles and Spanish subtitles, of elementary streams of videos included in the broadcast program 3, as the recording target elementary stream.

With the above-described configuration, the present exemplary embodiment can prevent the recording of the elementary stream that is not likely to be viewed.

The processing according to the present exemplary embodiment can be executed with the control units 503 through 506 of the user command execution unit 1033. In addition, the processing according to the present exemplary embodiment can be utilized in executing other control operations such as the search keyword extraction.

Furthermore, the present exemplary embodiment can select the elementary stream likely to be viewed later as the recording target elementary stream, as well as the currently viewed elementary stream, by extracting the search keyword by executing the above-described processing according to the present exemplary embodiment.

In addition, the present invention can be alternatively implemented by implementing each of the first through the third exemplary embodiments on the same digital television set 100 and causing the digital television set 100 to operate by appropriately shifting its operation mode as necessary.

The user command execution unit 1033 according to the present exemplary embodiment selects the elementary stream to be recorded from among all of the elementary streams of a specific broadcast program according to the viewing state. However, the present invention is not limited to this. That is, it is also useful if the viewing configuration storage unit 1031 does not select a specific elementary stream (datacasting, for example) as the recording target elementary stream regardless of its viewing state.

With the above-described configuration, the present exemplary embodiment can prevent the recording of an elementary stream that has been previously viewed by the user but the user does not desired to record.

Furthermore, the user command execution unit 1033 may cause the reproduction unit 104 to display the recording target elementary stream according to the additional command issued by the user. In this case, the user can execute the additional command by pressing an “enter” button (not illustrated), for example.

With the above-described configuration, the present exemplary embodiment can allow the user to verify the content data (elementary stream) to be recorded.

In the present exemplary embodiment, the digital television set 100 is described as an example of the selection apparatus configured to select a recording target from among a plurality of pieces of content data (elementary streams). However, the present invention is not limited to this.

That is, the present invention can be implemented not only by a digital television set but also by an apparatus capable of selecting recording target content data, such as a personal computer (PC), a workstation, a notebook-sized PC, a palmtop PC, various home appliances built in with a computer, a gaming machine, or a cellular phone or a combination thereof.

Furthermore, the present exemplary embodiment selects the recording target content data from among a plurality of pieces of digital content data.

Now, a case where the present invention is implemented on a digital versatile disc (DVD) recorder. In this case, the DVD recorder is constituted by the viewing configuration storage unit 1031 (FIG. 1) and the user command execution unit 1033 (FIG. 1) while the digital television set is constituted by the reproduction unit 104 and the blending unit 1032. It is supposed here that both the DVD recorder and the digital television set include the receiving and separation unit 101.

In this case, the above-described selection operation (operation for selecting (changing) a stream to be output from the blending unit 1032 to the reproduction unit 104) is performed with respect to the digital television set.

After receiving the selection operation, a selection unit (not illustrated) of the digital television set notifies the blending unit 1032 of the PID of the elementary stream to be output and also notifies the DVD recorder of the selected (changed) viewing configuration. After receiving the PID notification, the blending unit 1032 changes the video output and the audio output. Then, the blending unit 1032 outputs the new video and the new audio data to the reproduction unit 104.

Furthermore, the viewing configuration storage unit 1031 of the DVD recorder stores the notified viewing configuration.

That is, the selection unit of the digital television set selects the content data to be output from among a plurality of pieces of content data (elementary streams). In addition, the blending unit 1032 of the digital television set outputs the selected content data to the reproduction unit 104.

On the other hand, the additional command input via the user operation input unit 102 is input to the DVD recorder.

After receiving the additional command, the user command execution unit 1033 of the DVD recorder selects the elementary stream to be recorded according to the viewing configuration that has been stored on the viewing configuration storage unit 1031.

That is, the user command execution unit 1033 of the DVD recorder selects the content data currently being output by the blending unit 1032 as the recording target.

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes the present invention.

As the storage medium for supplying such program code, a floppy disk, a hard disk, an optical disk, a magneto-optical disk (MO), a compact disc read-only memory (CD-ROM), a compact disc recordable (CD-R), a compact disc rewritable (CD-RW), a magnetic tape, a nonvolatile memory card, a read only memory (ROM), and a digital versatile disc (DVD (DVD-recordable (DVD-R), DVD-rewritable (DVD-RW))), for example, can be used.

In addition, the functions according to the embodiments described above can be implemented not only by executing the program code read by the computer, but also implemented by the processing in which an operating system (OS) or the like carries out a part of or the whole of the actual processing based on an instruction given by the program code.

Further, in another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-043066 filed Feb. 25, 2008, which is hereby incorporated by reference herein in its entirety.

What is claimed is:

1. A selection apparatus configured to select a target of recording on a recording apparatus from among a plurality of pieces of digital content data included in a broadcast program, the selection apparatus comprising:
a first selection unit configured to select digital content data to be output to a reproduction apparatus from among the plurality of pieces of digital content data included in the broadcast program;
an output unit configured to output the digital content data selected by the first selection unit to the reproduction apparatus; and
a second selection unit configured to select the digital content data that is currently being output by the output unit as a target of recording on the recording apparatus.

2. The selection apparatus according to claim 1, further comprising a content data recording unit configured to record the digital content data on the recording apparatus according to selection by the second selection unit.

3. The selection apparatus according to claim 1, further comprising a keyword recording unit configured to record a keyword extracted from the digital content data selected by the second selection unit on the recording apparatus.

4. The selection apparatus according to claim 1, wherein the digital content data to be output by the output unit and the target of recording selected by the second selection unit are changed according to a change in digital content data to be output made by the first selection unit.

5. The selection apparatus according to claim 1, wherein the first selection unit includes a storage unit configured to store identification information of digital content data that has been previously output by the output unit, and
wherein the second selection unit is configured to select digital content data to be recorded according to the digital content data that has been previously output by the output unit.

6. The selection apparatus according to claim 5, wherein the storage unit is configured to store the identification information of the digital content data that has been previously output by the output unit and attribute information of the identification information while associating the identification information and the attribute information with each other, and
wherein the selection apparatus further comprises a deletion unit configured to delete identification information stored in the storage unit based on the attribute information.

7. The selection apparatus according to claim 5, wherein the storage unit is configured to store the identification information of the digital content data that has been previously output by the output unit and attribute information of the identification information while associating the identification information and the attribute information with each other, and
wherein the second selection unit is configured to select the digital content data to be recorded based on the identification information and the attribute information stored in the storage unit.

8. The selection apparatus according to claim 7, wherein the attribute information includes information generated based on time at which the digital content data was output by the output unit.

9. A method for selecting a target of recording on a recording apparatus from among a plurality of pieces of digital content data included in a broadcast program, the method comprising:
selecting digital content data to be output to a reproduction apparatus from among the plurality of pieces of digital content data included in the broadcast program;
outputting the selected digital content data to the reproduction apparatus; and
selecting the digital content data that is currently being output to the reproduction apparatus as a target of recording on the recording apparatus.

10. A computer-readable storage medium storing a computer-executable process, the computer-executable process implementing instructions for causing a computer to perform a method of selecting a target of recording on a recording apparatus from among a plurality of pieces of digital content data included in a broadcast program, the method comprising:
selecting digital content data to be output to a reproduction apparatus from among the plurality of pieces of digital content data included in the broadcast program;
outputting the selected digital content data to the reproduction apparatus; and
selecting the digital content data that is currently being output to the reproduction apparatus as a target of recording on the recording apparatus.
